(19) United States
(12) Patent Application Publication
(10) Pub. No.: US 2026/0273625 A1
(43) Pub. Date: Sep. 17, 2026

(54) METHOD OF LASER-ELECTRON BEAM COMPOSITE ADDITIVE MANUFACTURING AND SYSTEM THEREOF

(71) Applicant: SHANDONG UNIVERSITY, Jinan (CN)

(72) Inventors: Jilai WANG, Jinan (CN); Baojian LIU, Jinan (CN); Qingjun ZHOU, Jinan (CN); Ning GUO, Jinan (CN); Quhao LI, Jinan (CN); Yi WAN, Jinan (CN)

(21) Appl. No.: 19/561,867

(22) Filed: Mar. 10, 2026

(30) Foreign Application Priority Data
Mar. 12, 2025 (CN) 2025102892622

(51) Int. Cl. B22F 10/36; B22F 10/28; B22F 10/85; B22F 12/41; B22F 12/45; B22F 12/90; B33Y 10/00; B33Y 30/00; B33Y 50/02

(52) U.S. Cl. CPC B22F 10/36; B22F 10/28; B22F 10/85; B22F 12/41; B22F 12/45; B22F 12/90; B33Y 10/00; B33Y 30/00; B33Y 50/02; B22F 2998/10

(57) ABSTRACT

A method of laser-electron beam composite additive manufacturing, may include: melting metal powder by using an electron beam as heat source to form molten pool on substrate surface; acquiring average temperature, surface fluctuations, and defect occurrence rate of the molten pool in real time; when simultaneously the average temperature reaches set stable temperature range, the surface fluctuations decrease to set standard range, and the defect occurrence rate is lower than a set threshold, switching to using a laser as main heat source and the electron beam as auxiliary heat source; and, continuing to melt metal powder until a deposition is formed; during collaborative operation process of laser and electron beam, constructing energy distribution map based on multiple detection data to obtain temperature and morphology distributions of molten pool; and, adjusting power parameters of laser and electron beam in real time based on variations in temperature and morphology of molten pool.

### CROSS-REFERENCE TO RELATED APPLICATIONS

The present invention claims priority benefits to Chinese Patent Application No. 202510289262.2, entitled “METHOD OF LASER-ELECTRON BEAM COMPOSITE ADDITIVE MANUFACTURING AND SYSTEM THEREOF”, filed on Mar. 12, 2025, with the China National Intellectual Property Administration, which is incorporated herein by reference in its entirety and constitutes an integral part of the present invention for all purposes.

### TECHNICAL FIELD

The present invention relates to the field of laser-directed energy deposition and, in particular, to a method of laser-electron beam composite additive manufacturing and a system thereof.

### BACKGROUND

Typically, laser-directed energy deposition (L-DED) additive manufacturing relies primarily on a single laser heat source. However, the single laser heat source has certain limitations: the energy distribution of the laser heat source exhibits a Gaussian profile, leading to local overheating of the molten pool and uneven temperature distribution across different regions, which can easily cause defects such as cracks and deformation. To address the issues associated with the single laser heat source, existing technologies have disclosed methods that combine a laser heat source with other heat sources, for example:

Chinese patent (Publication No. CN109676138A, Publication Date Apr. 26, 2019) has disclosed a laser-excited ultrasonic energy field-assisted plasma arc-loaded powder additive manufacturing method, which employs an approach of coaxial powder feeding with metal powder and a plasma arc, where the plasma arc is used as a main heat source for melting the metal powder and enabling its deposition and shaping, and high-frequency pulsed laser energy is used to impact a plasma arc molten pool to excite an ultrasonic energy field within the molten pool, thereby forming a dense and fine-grained solidification microstructure in a deposited layer during a solidification process of the molten pool. This solution combines laser and plasma arc heat sources, but it is not suitable for workpieces with complex structures as required in the aerospace field.

Another Chinese patent (Publication No. CN110064756A, Publication Date Jul. 30, 2019) has disclosed a selective laser melting molding method, which involves scanning a powder layer with a first heat source and subsequently scanning a solid powder layer with a second heat source, where the energy density of the first heat source is lower than that of the second heat source. This solution does not provide specific operational details of coordinating the two heat sources.

In conclusion, although the aforementioned solutions involve two heat sources, they do not consider the rational utilization of energy, fail to achieve dynamic adjustment of parameters, and cannot effectively ensure work efficiency.

### SUMMARY

To overcome the deficiencies in the prior art, an objective of the present invention is to provide a method of laser-electron beam composite additive manufacturing and a system thereof, being capable of improving deposition accuracy, reducing the impact of thermal stress, minimizing defects, and achieving high-efficiency energy utilization.

To achieve the above objective, the present invention is implemented through the following technical solutions.

In a first aspect, an example of the present invention provides a method of laser-electron beam composite additive manufacturing, including:
melting metal powder by using an electron beam as a heat source, to form a molten pool on a surface of a substrate;
acquiring three metrics including temperature, morphology and depth, and surface defects of the molten pool in real time;
when the three metrics simultaneously satisfy preset conditions, switching to using a laser as a main heat source and the electron beam as an auxiliary heat source, and continuing to melt the metal powder until a deposition is formed;
wherein, during a collaborative operation process of the laser and the electron beam, constructing an energy distribution map based on multiple detection data, to obtain temperature and morphology distributions of the molten pool; and adjusting parameters of the laser and power parameters of the electron beam in real time based on variations in the temperature and morphology of the molten pool;
wherein, the preset conditions include: an average temperature of the molten pool reaches a set stable temperature range, surface fluctuations of the molten pool decrease to a set standard range, and a defect occurrence rate is lower than a set threshold.

As a further implementation mode, when the electron beam is used as the auxiliary heat source, the power of the electron beam is lower than that in a molten pool formation stage.

As a further implementation mode, acquiring an output of the power of the laser in real time by using a photodetector, acquiring an output of the power of the electron beam in real time by using a current transformer, and acquiring a state of the molten pool in real time by using a camera.

As a further implementation mode, the stable temperature range is 1,200 C°-1,400 C°, the set standard range for the surface fluctuations of the molten pool is 0.2 mm-0.5 mm, and the set threshold for the defect occurrence rate is 5%.

As a further implementation mode, the detection data include the power of the laser and the power, current, and morphology of the electron beam; and
establishing a relationship between the power corresponding to the laser and the electron beam and a state of the molten pool according to the detection data, to construct a heat source input feedback model.

As a further implementation mode, when the energy distribution map indicates insufficient thermal input from the laser in a set area, automatically increasing the power of the laser or adjusting a focal length of the laser; and
when the energy distribution map indicates excessive thermal input from the electron beam, automatically decreasing the power of the electron beam or adjusting the morphology thereof.

As a further implementation mode, the energy distribution map is represented by a power density model;
the heat source input feedback model includes a temperature feedback sub-model and a heat source input adjustment sub-model; and
obtaining a collaborative optimization feedback control model by combining the energy distribution map with the heat source input feedback model.

As a further implementation mode, during the collaborative operation process of the laser and the electron beam, a set overlapping area exists between a focus of the laser and a scanning area of the electron beam.

In a second aspect, an example of the present invention provides a system of laser-electron beam composite additive manufacturing, including:
a thermal emission electron gun, configured to emit an electron beam;
a laser device, configured to emit a laser;
an electron beam detection module, configured to detect performance parameters of the electron beam;
a laser detection module, configured to detect performance parameters of the laser; and
a control system, configured to automatically adjust morphologies of the electron beam and the laser according to the performance parameters of the electron beam and the performance parameters of the laser.

As a further implementation mode, the electron beam detection module includes:
a current transformer, configured to detect an output of power of the electron beam, and
a Hall sensor, configured to detect a flow state of the electron beam;
the laser detection module includes:
a photodetector, configured to detect an output of power of the laser, and
a laser focusing sensor, configured to detect a position and focus state of the laser.

The present invention has the following beneficial effects:
(1) according to the present invention, the electron beam serves as a single heat source in the molten pool formation stage, capable of providing extensive thermal input; in the fine deposition stage, the laser serves as the main heat source while the electron beam serves as the auxiliary heat source, with the electron beam enabling large-area uniform heating and the laser precisely controlling the surface morphology, and the collaborative operation of the two allows for more refined control of the entire molten pool, thereby enhancing the quality of the deposited layer; by selecting the more suitable heat source in different stages to fully utilize their respective roles, the objectives of reducing the impact of thermal stress and minimizing defects are achieved.
(2) according to present invention, switching conditions for transitioning from a single heat source to a composite heat source are established by using the temperature, morphology and depth, and surface defects of the molten pool as metrics, and the composite heat source is switched only when the three metrics meet the set conditions to achieve optimal results. Furthermore, various parameters can be dynamically adjusted to ensure optimal coordination of the temperature and fluidity of the molten pool during the deposition process, thereby improving deposition quality and efficiency, and ensuring the performance and precision of the final manufactured part.

### BRIEF DESCRIPTION OF THE DRAWINGS

The accompanying drawings as a part of the present invention are provided to further illustrate the present invention. The exemplary embodiments of the present invention and their descriptions are intended to explain the present invention and do not constitute an undue limitation thereon.

FIG. 1 is a flowchart of a method of laser-electron beam composite additive manufacturing according to one or more examples of the present invention;

FIG. 2 is a control process diagram of the laser-electron beam composite additive manufacturing according to one or more examples of the present invention; and

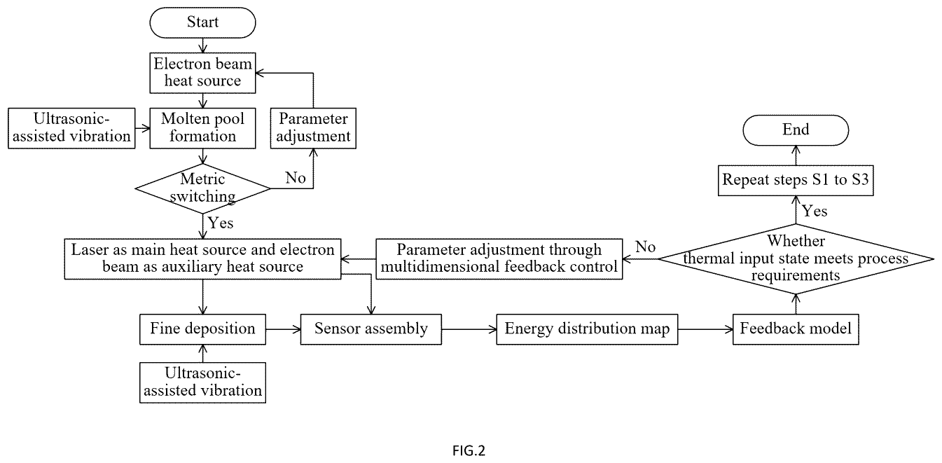

FIG. 3 is a structural diagram of a system of laser-electron beam composite additive manufacturing according to one or more examples of the present invention.

In the figures: 1, powder feeding gas source; 2, gas pressure valve; 3, powder feeder; 4, laser device; 5, substrate; 6, shielding gas source; 7, thermal emission electron gun; 8, electron beam; 9, formed part; and, 10, laser.

### DETAILED DESCRIPTION

It should be noted that the following detailed description is exemplary and aims to further describe the present invention. Unless otherwise specified, all technical and scientific terms used herein have the same meanings as those generally understood by a person of ordinary skill in the art to which the present invention belongs.

### Example 1

The present example provides a method of laser-electron beam composite additive manufacturing method, including:
melting metal powder by using an electron beam as a heat source, to form a molten pool on a substrate surface;
acquiring three metrics including: temperature, morphology and depth, and surface
defects of the molten pool in real time;
when the three metrics simultaneously satisfy preset conditions, switching to using a
laser as a main heat source and the electron beam as an auxiliary heat source, and continuing to melt the metal powder until a deposition is formed;
wherein, during a collaborative operation process of the laser and the electron beam, constructing an energy distribution map based on multiple detection data, to obtain temperature and morphology distributions of the molten pool; and adjusting parameters of the laser and power parameters of the electron beam in real time based on variations in the temperature and morphology of the molten pool;
wherein, the preset conditions include: an average temperature of the molten pool reaches a set stable temperature range, surface fluctuations of the molten pool decrease to a set standard range, and a defect occurrence rate is lower than a set threshold.

In the present example, in an initial stage (the molten pool formation stage), the electron beam is used as a sole heat source, capable of providing extensive thermal input, effectively avoiding local overheating issues while facilitating more uniform heating of the molten pool; in a fine deposition stage, the laser is used as the main heat source and the electron beam as the auxiliary heat source and, during the laser-dominated fine processing, the system continues to supply an appropriate amount of heat, thereby preventing excessive local temperature differences.

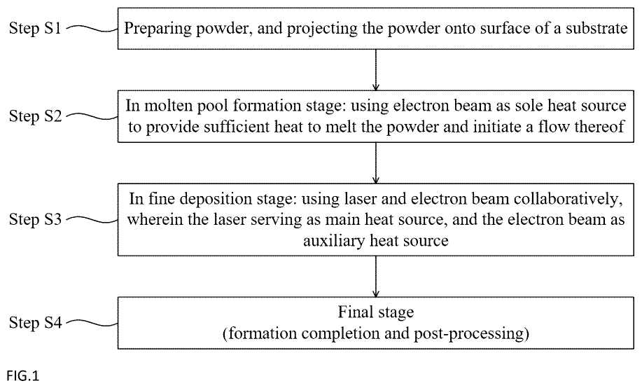

As shown in FIG. 1, the method of the laser-electron beam composite additive manufacturing provided in the present example specifically includes the following steps:

S1: preparing powder and projecting the powder onto a surface of a substrate.

Taking titanium alloy powder as an example, in the present example, selects Ti-6Al-4V titanium alloy powder is selected, and a particle size thereof is controlled within a range of 50-150 μm. Specifically, a particle size of 100 μm is selected as a reference value. The powder is sieved to remove particles larger than 150 μm and smaller than 50 μm, ensuring uniform particles free of impurities.

S2: in a molten pool formation stage, using the electron beam as the sole heat source to provide sufficient heat to melt the powder and initiate a flow of the powder.

Wherein, the power of the electron beam is set within a range of 4-10 kW to ensure adequate energy for melting the powder and forming a stable molten pool. For high thermal conductivity materials (such as aluminum alloys and copper alloys), a higher initial power is required, typically within a range of 6-12 kW; for low thermal conductivity materials (such as titanium alloys and nickel-based alloys), the initial power is typically within a range of 4-8 kW.

In the present example, a power of 5 KW and a scanning speed of 0.5 mm/s are selected for the electron beam, enabling rapid heating and melting of the titanium alloy powder to 1,600 C°, ensuring the molten pool forms uniformly across the entire working area and preventing local overheating.

A powder delivery system precisely jets the powder into the electron beam's heating zone via a gas flow, with the powder feed rate controlled at 1 g/s to ensure uniform powder deposition without excess. Simultaneously, an ultrasonic vibration system is activated at a set ultrasonic frequency of 25 kHz and a set amplitude of 20 μm. By applying high-frequency micro-vibrations within the molten pool, it aids metal liquid flow and reduces bubble formation.

During the scanning process, the electron beam interacts with the powder, transferring electron energy to the powder. The titanium alloy powder begins to melt, gradually merging with the substrate surface to form molten metal, thereby establishing a preliminary molten pool. Throughout the molten pool formation process, an infrared sensor monitors the temperature of the molten pool in real time and feeds the data back to a control system. If the temperature of the molten pool exceeds a predetermined range of 1,200 C°-1,400 C°, the system automatically adjusts the power of the electron beam to avoid quality issues caused by overheating.

As the electron beam heats and the powder gradually melts, the titanium alloy powder is progressively guided to form a stable molten pool. The morphology of the molten pool should gradually become uniform and stable. Typically, in the initial stage, the depth of the molten pool is shallow, controlled approximately within a range of 0.2-0.5 mm.

S3: in a fine deposition stage, using the laser and the electron beam collaboratively, with the laser serving as the main heat source and the electron beam as the auxiliary heat source.

The laser becomes the main heat source, while the power of the electron beam is gradually reduced to begin assisting in controlling the uniformity and stability of the molten pool. At this point, the laser provides finer thermal input, while the electron beam maintains low power, continuing to supply uniform thermal input to prevent overcooling of the molten pool. The focus of the laser and the scanning area of the electron beam maintain a certain degree of overlap rather than complete overlap. For example, when the electron beam scans the molten pool, its scanning area may cover approximately an area of 4-5 mm, while the focus of the laser may only be 2 mm. The focus of the laser should have its center located on the surface of the molten pool and perform precise local heating within the scanning area of the electron beam to achieve fine control.

After the molten pool stabilizes, to reduce excessive melting, minimize evaporation loss, and improve deposition quality, the power typically needs to be reduced by 30%-50%. In the present example, according to the electron beam process parameters from the molten pool formation stage, a power of 1,500 W, a focal length of 7 mm, and a spot size of 2 mm are selected for the laser. Simultaneously, the electron beam, as the auxiliary heat source, is reduced to a power of 3 KW. The frequency of the ultrasonic acoustic field continues to be set at 25 kHz, and the amplitude is adjusted to 15 μm.

Since the electron beam is used as the single heat source in the molten pool formation stage and a composite laser-electron beam heat source is used in the fine deposition stage, specific switching conditions must be met when transitioning from the single heat source to the composite heat source. In the present example, the temperature, morphology and depth, and defects of the molten pool serve as the three metrics within the switching conditions. When the three metrics all satisfy preset conditions, the switching conditions are fulfilled.

Further, regarding the temperature metric of the molten pool, since the power of the electron beam in the initial stage is set to 5 KW, primarily to provide extensive thermal input, the temperature of the molten pool gradually increases and stabilizes. In this stage, the temperature of the molten pool is typically high with significant fluctuations, but as the molten pool forms, the temperature gradually tends to stabilize

The average temperature of the molten pool must reach the set stable temperature range (1,200 C°-1,400 C°) and be maintained within this range. If temperature fluctuations are excessive (exceeding a set range of ±10 C°), switching to the laser as the main heat source should be delayed. In the present example, the infrared sensor collects temperature data from different positions on the surface of the molten pool. Due to spatial and temporal variations in the temperature of the molten pool, it requires to consider spatial weighting and temporal filtering when the average temperature is calculated.

Further, as the temperature at a center of the molten pool is typically higher than that at edge areas thereof, a weighted average of the temperature data is applied:

$${T}_{a v g} = \frac{{\sum }_{i = 1}^{N} {ω}_{i} {T}_{i}}{{\sum }_{i = 1}^{N} {ω}_{i}} ; \qquad ( 1 )$$

wherein, Tᵢ represents a temperature at an i^{th} measurement point; and ωᵢ represents a weight assigned to the present measurement point, typically assigned according to a distance from the present measurement point to the center of the molten pool (higher weight for central areas, lower weight for the edge areas).

The temperature of the molten pool exhibits short-term fluctuations; therefore, sliding window filtering is applied to reduce transient errors:

$${T}_{f i l t e red} ( t ) = \frac{1}{M} {\sum }_{j = 0}^{M - 1} {T}_{a v g} ( t - j ) ; \qquad ( 2 )$$

wherein, M represents a sliding window size (e.g., 5-10 sets of data), and t represents a transient time. The present method can smooth the temperature curve, preventing the transient errors generated in single measurements from affecting the decision.

A stable temperature range [Tₘᵢₙ, Tₘₐₓ] is set, and the temperature of the molten pool is considered stable when the following condition is met:

$${T}_{min} \leq {T}_{f i l t e r e d} \leq {T}_{max} ;$$

once the stability condition is satisfied, the heat source mode can be switched or the power parameters of the laser and the electron beam can be optimized.

Regarding the morphology and depth of the molten pool: in the initial stage, the depth of the molten pool is typically shallow, ranging between 0.2-0.5 mm, and the surface of the molten pool may exhibit minor fluctuations and irregular shapes. However, these fluctuations will be improved in subsequent stages. When the molten pool depth stabilizes and surface fluctuations decrease to the set standard range (depth stabilized at 0.3 mm, surface fluctuation amplitude below 0.05 mm), it indicates the molten pool has reached a state suitable for further fine control.

Regarding the defects of the molten pool, in the initial stage, although the molten pool begins to form under heating by the electron beam, defects such as pores or cracks may be present. A high-speed camera monitors the surface defects of the molten pool, particularly checking for cracks, pores, etc. When the defect occurrence rate falls below the set threshold of 5%, switching can proceed. In the present example, the high-speed camera is configured to detect the surface defects of the molten pool, such as abnormal surface roughness, cracks, and spatter. The surface defect occurrence rate is expressed as follows:

$${DOR}_{s u r f} = \frac{{N}_{d e f e c t}}{{N}_{t otal}} \times 1 \; 00 \% ;$$

wherein, N_{defect} represents the number of surface defects detected (e.g., abnormal molten pool morphologies identified per unit time); and Nₜₒₜₐₗ represents the number of molten pool frames analyzed during a corresponding period of time.

Therefore, when the temperature remains within the target range with minimal fluctuations (within ±10 C°), the depth and surface fluctuations of the molten pool are stable (depth within the predetermined range of 0.2-0.4 mm), and the defect occurrence rate (e.g., cracks, pores, etc.) is below the set tolerance value of 5%, indicating that the molten pool has stabilized. Then, it is time to switch to the laser as the main heat source.

Simultaneously, in the fine deposition stage, multiple detection data are collected through various sensors and transmitted to the control system to construct the energy distribution map. A multidimensional feedback control method based on the morphology of the molten pool and the temperature field processes signals. Based on variations in the temperature and morphology of the molten pool, the power, focal length, and scanning speed of the laser are adjusted, while the power of the electron beam is also adjusted to avoid local overheating or uneven thermal input.

Further, the detection data are acquired by corresponding sensors, including a photodetector, a current transformer, a Hall sensor, an infrared sensor, a high-speed camera, and a laser focusing sensor, where the photodetector is configured to detect the output power of the laser in real time, variations in the power of the laser affect a local temperature of the molten pool, and according to real-time power data fed back by the photodetector, it is determined whether power fluctuations or excessive concentration exist; the current transformer is configured to detect the power output of the electron beam, and variations in current reflect beam intensity, thereby affecting thermal input; the Hall sensor is configured to detect the morphology of charged particles such as the electron beam, and the morphology of the electron beam refers to the width, shape, and focus position of the electron beam. If the morphology of the electron beam is unstable (deviating from a preset path), the thermal input from the electron beam becomes uneven; therefore, the Hall sensor enables real-time monitoring of beam current stability.

The focus position and beam shape of the laser directly affect molten pool formation. If the laser beam is not precisely focused or the spot deviates, the laser's heating effect will be impacted; therefore, the laser focusing sensor is configured to monitor the laser's focus state in real time, ensuring it aligns with a predetermined position. The infrared sensor is configured to monitor the temperature distribution across the entire area, and the high-speed camera captures morphological variations of the molten pool through high-frequency imaging to monitor the state of the molten pool.

To ensure uniform thermal input when the two heat sources operate collaboratively, the collected data (power, current, morphology of the electron beam, etc.) must be comprehensively analyzed using the energy distribution map and a heat source input feedback model.

Further, the heat source input of the laser and the electron beam can be modeled through power density distribution. By using sensors to monitor the output power of the laser and the power output, current, and morphology of the electron beam in real time, the energy distribution within the molten pool can be calculated, and the energy distribution map can be represented by a power density model, i.e., a non-uniform energy distribution model:

$$E ( x , y , t ) = {P}_{laser} ( t ) \cdot {f}_{laser} ( x , y ) + {P}_{e - beam} ( t ) \cdot {f}_{e - beam} ( x , y ) ; \qquad ( 4 )$$

wherein, E(x, y, t) represents a local energy density at a position (x, y) in the molten pool, expressed in W/m²;
Pₗₐₛₑᵣ(t) represents a power input of the laser, and P_{e-beam}(t) represents a power input of the electron beam, both varying over time;
fₗₐₛₑᵣ(x, y) represents a spatial distribution function of the laser on the surface of the molten pool, and f_{e-beam}(x, y) represents a spatial distribution function of the electron beam on the surface of the molten pool, describing how energy is distributed across the surface of the molten pool. Typically, fₗₐₛₑᵣ(x, y) and f_{e-beam}(x, y) are related to the shape of the heat source (e.g., laser spot, electron beam morphology).

In practical applications, the aforementioned functions can be dynamically adjusted based on variations in the morphology of the molten pool. The energy distribution of the laser generally exhibits a Gaussian profile, while the distribution of the electron beam depends on the current geometry and focusing state.

The heat source input feedback model must not only consider the distribution of power density but also adjust the operating parameters of the heat source according to the state of the molten pool (e.g., temperature, morphology). By monitoring feedback signals such as temperature and morphology in real time, the system can optimize the thermal input distribution. Therefore, it includes:

Temperature feedback sub-model:
according to the thermal dynamic characteristics of the molten pool, the variations in temperature exhibit a nonlinear relationship with the heat source input, and a local temperature of the molten pool can be expressed as follows:

$$T ( x , y , t ) = {\int }_{0}^{t} [ {α}_{laser} \cdot {P}_{laser} ( {t}^{′} ) \cdot {f}_{laser} ( x , y ) + {α}_{e - beam} {P}_{e - beam} ( {t}^{′} ) \cdot {f}_{e - beam} ( x , y ) ] {dt}^{′} ; \qquad ( 5 )$$

wherein, T(x, y, t) represents a local temperature at a specific position in the molten pool; αₗₐₛₑᵣ represents a heat transfer coefficient of the laser, while α_{e-beam} represents a heat transfer coefficient of the electron beam, both depending on the material and thermal conductivity characteristics of the molten pool; the integral term represents a cumulative effect of the heat source input on the local temperature, with the temperature continuously updating over time.

Heat source input adjustment sub-model:
based on the local temperature, morphology (e.g., depth, width), and real-time energy distribution of the molten pool, the power of the laser and the power of the electron beam can be dynamically adjusted through heat source input feedback:

$$Δ {P}_{laser} ( t ) = {β}_{1} \cdot ( {T}_{max} ( t ) - {T}_{t a r g e t} ( t ) ) \cdot {f}_{laser} ( x , y ) + {β}_{2} \cdot ( {I}_{b e a m} ( t ) - {I}_{b e a m , t a r g e t} ) \cdot {f}_{e - beam} ( x , y ) ; \qquad ( 6 )$$

wherein, Tₘₐₓ(t) represents a maximum temperature on the surface of the molten pool; T_{target}(t) represents a target temperature; I_{beam}(t) represents an actual current of the electron beam; I_{beam}, target represents a target current of the electron beam; β₁ and β₂ represent adjustment coefficients that control the response sensitivity of feedback.

Formula (6) integrates feedback on the temperature of the molten pool and the morphology of the electron beam, enabling the maintenance of thermal input uniformity by dynamically adjusting the power of the laser and the power of the electron beam based on real-time monitoring of the state of the molten pool.

The heat source input feedback model establishes a relationship between the power of the laser, the power of the electron beam, and the state of the molten pool. When a variation in data such as the temperature, the beam current state, and the power occurs, the heat source input feedback model can determine whether the current thermal input state meets process requirements in real time. If the thermal input of a heat source (such as the laser or the electron beam) is insufficient, or if a specific area is overheated, the control system adjusts the output parameters of the heat source.

For example: if the energy distribution map indicates insufficient thermal input from the laser in certain areas, the system will automatically increase the power of the laser or adjust the focal length of the laser to precisely heat those areas. If the thermal input from the electron beam is excessive, causing overheating in some areas, the control system can appropriately reduce the power of the electron beam or adjust the morphology of the electron beam to achieve a more uniform thermal input distribution.

A thermal input Q can be determined by factors such as the power, scanning speed, and spot/beam current size of the heat source and is calculated as follows:

$$Q = \frac{P}{A \cdot ν} ; \qquad ( 7 )$$

wherein, P represents the power of the heat source (W), including the power of the laser P_{L} and the power of the electron beam P_{E}; A represents a spot/beam current coverage area (mm²); and, v represents the scanning speed (mm/s).

In the present example, by integrating the heat source input feedback model with the energy distribution map, a collaborative optimization feedback control model is constructed, for ensuring coordinated thermal input between the laser and the electron beam to maintain a stable and uniform temperature distribution in the molten pool.

The collaborative optimization feedback control model is expressed as follows:

$$Δ {P}_{laser} ( t ) = {γ}_{1} ( {\int }_{{x}_{1}}^{{x}_{2}} {\int }_{{y}_{1}}^{{y}_{2}} E ( x , y , t ) dxdy - {E}_{t a r g e t} ) \cdot ( 1 + {( \frac{d ( t )}{ω ( t )} )}^{{δ}_{1}} ) \qquad ( 8 )$$

$$Δ {P}_{e - beam} ( t ) = {γ}_{2} ( {\int }_{{x}_{1}}^{{x}_{2}} {\int }_{{y}_{1}}^{{y}_{2}} E ( x , y , t ) dxdy - {E}_{t a r g e t} ) \cdot ( 1 + {( \frac{d ( t )}{ω ( t )} )}^{{δ}_{2}} ) ;$$

wherein,

$${\int }_{{x}_{1}}^{{x}_{2}} {\int }_{{y}_{1}}^{{y}_{2}} E ( x , y , t )$$

dx dy represents a total thermal input in a specific area of the molten pool; the ranges of x₁~x₂ and y₁~y₂ represent boundaries of the molten pool within a sensor detection or control area and can be dynamically adjusted based on sensor data to ensure precise control of thermal input across the entire molten pool area. E_{target} represents a target energy density for that area; γ₁ and γ₂ represent adjustment coefficients used to adjust the power output of the laser and the electron beam; d(t) represents the depth of the molten pool; ω(t) represents the width of the molten pool, reflecting the influence of variations in the morphology of the molten pool on heat source adjustment; and, δ₁ and δ₂ represent adjustment indexes related to the variations in the morphology of the molten pool.

Based on the above formula, the present example achieves precise power adjustment of the laser and the electron beam through the energy distribution map and the morphological characteristics of the molten pool. This enables the adjustment of their respective thermal inputs based on real-time feedback, ensuring the stability and uniformity of the molten pool.

To further optimize the deposition process of the molten pool, multiple morphological parameters of the molten pool such as depth, width, and height can be integrated to construct a multidimensional feedback control model:

$$Δ {P}_{laser} ( t ) = {α}_{3} \cdot {( \frac{d ( t )}{ω ( t )} )}^{{β}_{3}} \cdot ( {T}_{max} ( t ) - {T}_{t a r g e t} ( t ) ) + {α}_{4} \cdot {( \frac{d ( t )}{h ( t )} )}^{{β}_{4}} ( {I}_{b e a m} ( t ) - {I}_{b e a m , t a r g e t} ) ; \qquad ( 9 )$$

wherein,

$$\frac{d ( t )}{ω ( t )}$$

represents a depth-to-width ratio of the molten pool, and

$$\frac{d ( t )}{h ( t )}$$

represents a depth-to-height ratio of the molten pool, both used to describe variations in the morphology of the molten pool; α₃, α₄, β₃, and β₄ represent adjustment coefficients that control the response sensitivity of the control system.

S4: final stage (formation completion and post-processing):

Deposition completion: the laser and the electron beam continue to cooperate until the deposition of the titanium alloy layer is completed, forming a target complex structure. During the deposition of each layer, a scanning speed of 0.2 mm/s is employed to ensure uniform and defect-free deposition of each layer.

Cooling and formation: after deposition is completed, an automatic cooling control system is used to gradually cool the molten pool to ambient temperature, preventing thermal stress and deformation. Additionally, annealing heat treatment is performed to enhance the mechanical properties of the titanium alloy.

Non-destructive testing is performed on the deposited product using X-ray testing and ultrasonic testing to ensure the absence of internal defects. Dimensional accuracy inspection is also performed on the deposited titanium alloy part to verify compliance with design specifications.

The present example employs a laser-electron beam composite heat source. The high precision of the laser enables control over surface melting, while the electron beam assists in heating a larger area, resulting in a more uniform thermal distribution throughout the molten pool. The combination of the two allows them to play distinct roles at different stages, ensuring deposition quality. During the deposition process, an ultrasonic acoustic field is applied to generate vibrations in the deposition zone. This enhances the fluidity of the molten pool and facilitates bubble expulsion, thereby reducing pore formation.

The present example, by integrating the laser-electron beam composite heat source with ultrasonic acoustic field assistance, can effectively address issues in L-DED such as uneven thermal input, molten pool instability, cracks, and pores. Furthermore, it enables real-time dynamic adjustment of various parameters, ensuring optimal coordination between molten pool temperature and fluidity during the deposition process. This improves deposition quality and efficiency, and guarantees the performance and precision of the final formed part.

### Example 2

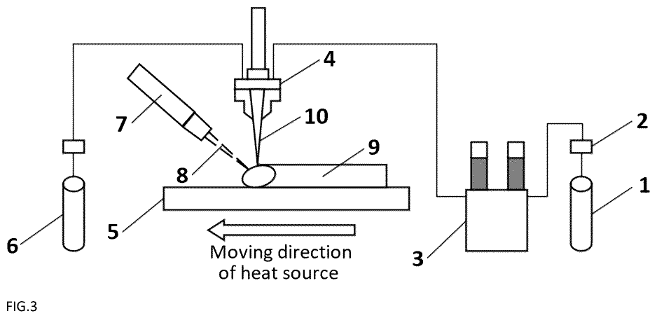

The present example provides a system of laser-electron beam composite additive manufacturing, as shown in FIG. 3, the system includes a thermal emission electron gun 7, a laser device 4, an electron beam detection module, and a laser detection module, where the laser device 4 is connected to a shielding gas source 6 and a powder delivery system, respectively, and the powder delivery system includes a powder feeding gas source 1 and a powder feeder 3 connected in sequence, with a gas pressure valve 2 installed on a pipeline between the powder feeding gas source 1 and the powder feeder 3. In the present example, the shielding gas source 6 and the powder feeding gas source 1 contain argon gas, respectively.

The laser device 4 is disposed above a substrate 5, and the thermal emission electron gun 7 is disposed on one side of the laser device 4. The thermal emission electron gun 7 is configured to emit an electron beam 8; the laser device 4 is configured to emit a laser 10; in an initial stage, only the thermal emission electron gun 7 operates; in a molten pool formation stage, the thermal emission electron gun 7 and the laser device 4 operate collaboratively, with the laser device 4 as a main heat source and the thermal emission electron gun 7 as an auxiliary heat source.

The laser detection module includes a photodetector and a laser focusing sensor, where the photodetector is configured to detect an output power of the laser 10 and is installed on the laser device 4 near an output end of the laser 10; a specific installation position of the photodetector must avoid obstructing a laser beam; and the photodetector forms a 45° angle with a path of the laser 10 to capture scattered or reflected light signals. The laser focusing sensor is configured to detect a position and focus state of the laser 10 and is disposed on a periphery of a head portion of the laser device 4, aimed at an emission point of the laser 10.

The electron beam detection module includes a current transformer and a Hall sensor, where the current transformer is configured to detect a power output of the electron beam 8 and is installed on the thermal emission electron gun 7; the current transformer is electromagnetically shielded to prevent high-frequency noise generated by the electron beam 8 from affecting signals; the Hall sensor is configured to detect a flow state of the electron beam 8 and is installed near a focusing coil of the electron beam 8, close to a path of the electron beam 8 but avoiding direct bombardment of the sensor by the electron beam 8 to prevent damage.

The system further includes an infrared sensor and a high-speed camera, where the infrared sensor is configured to monitor a temperature distribution across an entire area and is installed above a molten pool, with a field of view covering the entire molten pool area; the infrared sensor must maintain a certain distance from the molten pool to avoid damage from high temperatures. Additionally, a high-temperature-resistant sapphire window can be used to prevent lens contamination from metal vapor. The high-speed camera captures morphological variations of the molten pool through high-frequency imaging to monitor the state of the molten pool. It is installed on a side of the molten pool, with a field of view covering the dynamic process of the molten pool, and features air-cooling protection for high-temperature environments and is equipped with a microsecond-level shutter to capture transient variations in the molten pool.

In the present example, different sensors cover key areas such as the molten pool respectively, and mutual obstruction or interference during use is avoided. Furthermore, key data (e.g., the temperature of the molten pool) can be cross-validated through multiple sensors (thermal imaging by the infrared sensor+the high-speed camera).

Temporal control for the fusion of data from multiple sensors is primarily achieved by a Field-Programmable Gate Array (FPGA) master controller generating a synchronous pulse signal, which simultaneously triggers acquisition from all sensors to ensure time synchronization and accurately reflect the transient state of the molten pool. This technique is known in the prior art and will not be elaborated herein. All the aforementioned sensors are connected to a control system, which automatically adjusts the morphologies of the electron beam 8 and the laser 10 according to performance parameters of the electron beam 8 and the laser 10.

In the present example, through the coordination of the thermal emission electron gun 7 and the laser device 4, only the thermal emission electron gun operates in the initial stage, while the thermal emission electron gun 7 and the laser device 4 operate collaboratively in the molten pool formation stage, ultimately forming the formed part 9.

Through a reasonable power ratio and relative position control, the laser 10 and the electron beam 8 in the present example can complement each other, achieving efficient energy utilization and making the additive manufacturing process more stable and efficient. The present example is particularly suitable for processing complex structural parts in the aerospace field.

The above descriptions are merely illustrative of the exemplary embodiments of the present invention and are not intended to limit the present invention. For those skilled in the art, various modifications and changes may be made to the present invention. Any amendments, equivalent substitutions, and improvements made within the spirit and principle of the present application shall be included within the scope of protection of the present application.

1. A laser-electron beam composite additive manufacturing method, comprising:
melting metal powder by using an electron beam as a heat source to form a molten pool on a surface of a substrate; acquiring three metrics comprising temperature, morphology and depth, and surface defects of the molten pool in real time; when the three metrics simultaneously satisfy preset conditions, switching to using a laser as a main heat source and the electron beam as an auxiliary heat source; and continuing to melt the metal powder until a deposition is formed; wherein,
during a collaborative operation process of the laser and the electron beam, constructing an energy distribution map based on multiple detection data to obtain temperature and morphology distributions of the molten pool; and adjusting a power and a focal length of the laser as well as a power and a morphology of the electron beam in real time based on variations in the temperature and morphology of the molten pool;
wherein, the preset conditions comprise: the temperature of the molten pool reaches a set stable temperature range, surface fluctuations of the molten pool decrease to a set standard range, and a defect occurrence rate is lower than a set threshold.

2. The method of the laser-electron beam composite additive manufacturing of claim 1, wherein when the electron beam is used as the auxiliary heat source, a power of the electron beam is lower than the power of the electron beam in a molten pool formation stage.

3. The method of the laser-electron beam composite additive manufacturing of claim 1, wherein acquiring an output of the power of the laser in real time by using a photodetector, acquiring an output of the power of the electron beam in real time by using a current transformer, and acquiring a state of the molten pool in real time by using a camera.

4. The method of the laser-electron beam composite additive manufacturing of claim 1, wherein the stable temperature range is 1,200 C°-1,400 C°, the set standard range for the surface fluctuations of the molten pool is that a depth is stabilized at 0.3 mm and a surface fluctuation amplitude is below 0.05 mm, and the set threshold for the defect occurrence rate is 5%.

5. The method of the laser-electron beam composite additive manufacturing of claim 1, wherein the detection data comprise the power of the laser, the power of the electron beam, a current of the electron beam, the morphology of the electron beam, and a focus state of the laser; and
establishing a relationship between the power corresponding to the laser and the electron beam and a state of the molten pool according to the detection data, and constructing a heat source input feedback model.

6. The method of the laser-electron beam composite additive manufacturing of claim 1, wherein when the energy distribution map indicates insufficient thermal input from the laser in a set area, automatically increasing the power of the laser or adjusting the focal length of the laser; and, when the energy distribution map indicates excessive thermal input from the electron beam, automatically decreasing the power of the electron beam or adjusting the morphology of the electron beam.

7. The method of the laser-electron beam composite additive manufacturing of claim 5, wherein the energy distribution map is represented by a power density model; a heat source input feedback model comprises a temperature feedback sub-model and a heat source input adjustment sub-model; and
obtaining a collaborative optimization feedback control model by combining the energy distribution map with the heat source input feedback model.

8. The method of the laser-electron beam composite additive manufacturing of claim 1, wherein during the collaborative operation process of the laser and the electron beam, a set overlapping area exists between a focus of the laser and a scanning area of the electron beam.

9. A system for the method of the laser-electron beam composite additive manufacturing of claim 1, comprising:
a thermal emission electron gun, configured to emit the electron beam;
a laser device, configured to emit the laser;
an electron beam detection module, configured to detect performance parameters of the electron beam;
a laser detection module, configured to detect performance parameters of the laser; and
a control system, configured to adjust the power and the focal length of the laser as well as the power and the morphology of the electron beam in real time based on variations in the temperature and morphology of the molten pool.

10. The system for the method of the laser-electron beam composite additive manufacturing of claim 9, wherein the electron beam detection module comprises: a current transformer and a Hall sensor, wherein the current transformer is configured to detect an output of the power of the electron beam, and the Hall sensor is configured to detect a flow state of the electron beam; and
the laser detection module comprises: a photodetector and a laser focusing sensor, wherein the photodetector is configured to detect an output of the power of the laser, and the laser focusing sensor is configured to detect a position and focus state of the laser.

11. The method of the laser-electron beam composite additive manufacturing of claim 2, wherein acquiring an output of the power of the laser in real time by using a photodetector, acquiring an output of the power of the electron beam in real time by using a current transformer, and acquiring a state of the molten pool in real time by using a camera.

12. The method of the laser-electron beam composite additive manufacturing of claim 5, wherein when the energy distribution map indicates insufficient thermal input from the laser in a set area, automatically increasing the power of the laser or adjusting the focal length of the laser; and, when the energy distribution map indicates excessive thermal input from the electron beam, automatically decreasing the power of the electron beam or adjusting the morphology of the electron beam.
